(19) United States
(12) Patent Application Publication
(10) Pub. No.: US 2023/0186572 A1
(43) Pub. Date: Jun. 15, 2023

(54) REALITY SPACE-BASED CONTENT AUTHORING DEVICE, CONTENT AUTHORING SYSTEM AND METHOD

(71) Applicant: MAXST CO., LTD., Seoul (KR)

(72) Inventors: Tae Hong JEONG, Gyeonggi-do (KR); Seung Lee KIM, Seoul (KR); Kyu Sung CHO, Gyeonggi-do (KR); Jae Wan PARK, Gyeonggi-do (KR)

(21) Appl. No.: 17/694,823

(22) Filed: Mar. 15, 2022

(30) Foreign Application Priority Data
Dec. 13, 2021 (KR) 10-2021-0177428

(51) Int. Cl. G06T 19/00; G06T 19/20; G06T 17/20; G06T 11/00; G06F 30/20

(52) U.S. Cl. CPC G06T 19/006; G06T 19/20; G06T 17/20; G06T 11/00; G06F 30/20; G06T 2219/2004; G06T 2210/32; G06T 2210/56; G06F 2111/18

(57) ABSTRACT

A reality space-based content authoring system according to an embodiment of the present disclosure includes an augmented reality server configured to provide augmented reality information including indoor and outdoor position information and simulation data of an augmented reality application user terminal necessary for simulation of content being authored and an operation of a distributed augmented reality application, a virtual reality server configured to provide reality space-based virtual reality information including geometric information and image information indicating a reality space to which the content is to be applied, and a content authoring device configured to provide a reality space-based virtual reality authoring environment when producing the content on the basis of the augmented reality information and the virtual reality information, and provide an augmented reality application and a virtual reality application based on the created content.

### GOVERNMENT LICENSE RIGHTS

This work was supported by Industrial Strategic Technology Development Program-Electronic System Industrial Technology Development Project (Project Identification No. 1415178235, Development of Industrial AR Support Platform Technology for Integrated Work Support in Manufacturing Site) funded By the Ministry of Trade, Industry & Energy (MOTIE, Korea). The government has certain rights in the invention.

### CROSS-REFERENCE TO RELATED APPLICATION(S)

This application claims the benefit under 35 USC § 119 of Korean Patent Application No. 10-2021-0177428, filed on Dec. 13, 2021, in the Korean Intellectual Property Office, the entire disclosure of which is incorporated herein by reference for all purposes.

### BACKGROUND

### 1. Field

The disclosed embodiments relate to a reality space-based content authoring device, a content authoring system and a content authoring method.

### 2. Description of Related Art

Augmented reality (AR) is to combine virtual objects or information in a real environment to make the virtual objects or information look like objects that exist in reality. In addition, virtual reality (VR) is to form a specific environment or situation into a virtual world to allow users to interact with their surroundings and environments as in real life.

Meanwhile, various augmented reality applications may provide high sense of presence and practicality at the same time based on content targeting a specific reality space. The content reflected in the augmented reality application is authored after repeatedly visiting the reality space, and thus it may take a relatively large amount of time and money.

### SUMMARY

The disclosed embodiments are intended to provide a reality space-based content authoring device, a content authoring system, and a content authoring method for enabling authoring of content in a reality space-based virtual reality authoring environment without directly visiting the site.

In addition, the disclosed embodiments are intended to enable authoring of content that may be applied to both augmented reality application and virtual reality application in a single authoring environment.

In addition, the disclosed embodiments are intended to enable the same content to be applied to both virtual reality application and augmented reality application.

According to an embodiment of the present disclosure, a reality space-based content authoring system includes an augmented reality server configured to provide augmented reality information including indoor and outdoor position information and simulation data of an augmented reality application user terminal necessary for simulation of content being authored and an operation of a distributed augmented reality application, a virtual reality server configured to provide reality space-based virtual reality information including geometric information and image information indicating a reality space to which the content is to be applied, and a content authoring device configured to provide a reality space-based virtual reality authoring environment when producing the content on the basis of the augmented reality information and the virtual reality information and provide an augmented reality application and a virtual reality application based on the created content.

The content authoring device may include a content renderer configured to perform rendering processing of content being authored or authored content, a virtual reality renderer configured to perform rendering processing of virtual reality corresponding to a reality space in the reality space-based virtual reality authoring environment by using at least one of the geometric information and the image information and provide a three-dimensional virtual reality environment using the geometric information and the image information, or providing a two-dimensional virtual reality environment of the reality space without the geometric information by using the image information, or providing visualization in a virtual reality environment when content is authored using the geometric information, and a content authoring unit configured to author the content in the reality space-based virtual reality authoring environment, and match and provide rendering of the virtual reality corresponding to the reality space and rendering of the content.

The content authoring unit may be configured to perform content authoring processing by placing the content and adjusting a position of the content according to a user's manipulation input in a specific space of the reality space-based virtual reality authoring environment, and the position of the content may coincide with a position where the content is to be displayed in the reality space when the augmented reality application is executed.

The content authoring device may further include a content simulator configured to simulate a result when the augmented reality application and the virtual reality application to which the authored content is applied are executed.

The content authoring device may further include an application provider configured to provide the augmented reality application and the virtual reality application to which the authored content is applied, and provide any one of the requested augmented reality application and the virtual reality application to a selected platform.

The content authoring unit may be configured to generate and place a two-dimensional object or a three-dimensional object in a reality space-based three-dimensional virtual reality space according to a user's manipulation input, and match the rendering of the content with the rendering of the virtual reality corresponding to the reality space to which the content being authored is applied.

The content authoring system may further include a storage device configured to store and manage the simulation data, the geometric information, and the image information to provide the stored information in response to a request of the content authoring device.

The simulation data may be composed of a sequence of video frames captured in the reality space and information corresponding to each frame.

The information corresponding to each frame may include a camera internal parameter, a camera external parameter, and position information.

The position information may be GPS information including latitude and longitude.

The geometric information may be in a format including a point cloud format and a mesh format.

According to another embodiment of the present disclosure, a reality space-based content authoring device includes a content renderer configured to perform rendering processing of content being authored or authored content, a virtual reality renderer configured to perform rendering processing of virtual reality corresponding to a reality space in a reality space-based virtual reality authoring environment by using at least one of geometric information and image information and provide a three-dimensional virtual reality environment using the geometric information and the image information, or provide a two-dimensional virtual reality environment of a reality space without the geometric information by using the image information, or provide visualization in a virtual reality environment when content is authored using the geometric information, and a content authoring unit configured to author the content in the reality space-based virtual reality authoring environment, and match and provide rendering of the virtual reality corresponding to the reality space and rendering of the content.

The content authoring unit may be configured to perform content authoring processing by placing the content and adjusting a position of the content according to a user's manipulation input in a specific space of the reality space-based virtual reality authoring environment, and the position of the content may coincide with a position where the content is to be displayed in the reality space when the augmented reality application is executed.

The content authoring unit may be configured to generate and place a two-dimensional object or a three-dimensional object in a reality space-based three-dimensional virtual reality space according to a user's manipulation input, and match the rendering of the content with the rendering of the virtual reality corresponding to the reality space to which the content being authored is applied.

The content authoring device may further include a content simulator configured to simulate a result when the augmented reality application and the virtual reality application are executed on the basis of the authored content and an application provider configured to provide the augmented reality application and the virtual reality application to which the authored content is applied, and provide any one of the requested augmented reality application and the virtual reality application to a selected platform.

According to still another embodiment of the present disclosure, a reality space-based content authoring method includes constructing augmented reality information including indoor and outdoor position information and simulation data of an augmented reality application user terminal necessary for simulation of content being authored and an operation of a distributed augmented reality application, constructing reality space-based virtual reality information including geometric information and image information indicating a reality space to which the content is to be applied, constructing a reality space-based virtual reality authoring environment for a specific space in which content is to be authored, performing content authoring processing by placing the content and adjusting the position of the content according to a user's manipulation input in the specific space, and providing an augmented reality application and a virtual reality application based on the authored content.

In the constructing of the reality space-based virtual reality authoring environment, rendering processing of virtual reality corresponding to the reality space in the authoring environment may be performed using the geometric information and the image information.

In the performing of the content authoring processing, the content may be authored in the reality space-based virtual reality authoring environment, and the rendering of the virtual reality corresponding to the reality space may be matched with the rendering of the content.

In the performing of the content authoring processing, a result when the augmented reality application and the virtual reality application is executed on the basis of the authored content may be simulated.

The providing of the augmented reality application and the virtual reality application may include selecting an application to be provided among the augmented reality application and the virtual reality application, selecting a platform to which any one of the selected augmented reality application and the virtual reality application is to be applied, and providing any one of the augmented reality application and the virtual reality application to the selected platform.

According to the disclosed embodiments, as content that can be applied to both augmented reality application and virtual reality application is authored in a single virtual reality authoring environment targeting a reality space, the time and cost required for content authoring are reduced, thereby capable of promoting the dissemination of related content.

In addition, according to the disclosed embodiments, in authoring the content, it can be expected to improve quality of augmented reality and virtual reality implementation as more iterations and modifications are possible within a schedule and within a budget.

In addition, according to the disclosed embodiments, the content authoring method becomes easier, and thus the participation of non-experts in content authoring can be promoted.

In addition, according to the disclosed embodiments, the augmented reality application and the virtual reality application targeting the reality space can be constructed and distributed at one time, thereby capable of reducing the time and cost required for the development and dissemination of extended reality metaverse platform application services.

### BRIEF DESCRIPTION OF THE DRAWINGS

FIG. 1 is a block diagram for illustrating a realty space-based content authoring system according to an embodiment.

FIG. 2 is a diagram for illustrating a rough concept of a realty space-based content authoring method according to an embodiment.

FIGS. 3A to 3C are diagrams illustrating examples of geometric information and image information and image-based rendering using the same according to an embodiment.

FIGS. 4A to 4C are diagrams illustrating examples of virtual reality rendering viewed from outside a space according to an embodiment.

FIGS. 5A to 5C are diagrams illustrating examples of virtual reality rendering viewed from inside the space according to an embodiment.

FIG. 6 is a diagram illustrating an example of rendering in a content authoring unit according to an embodiment.

FIG. 7A is an exemplary diagram for illustrating an operation in the content authoring unit according to an embodiment.

FIG. 7B is an exemplary diagram for illustrating an operation in a content simulator according to an embodiment.

FIG. 8 is an exemplary diagram for illustrating an augmented reality content authoring method according to an embodiment.

FIG. 9 is an exemplary diagram for illustrating an augmented reality content simulation method according to an embodiment.

FIG. 10 is a flowchart for describing a reality space-based content authoring method according to an embodiment.

FIG. 11 is a block diagram for illustratively describing a computing environment including a computing device according to an embodiment.

### DETAILED DESCRIPTION

Hereinafter, a specific embodiment will be described with reference to the drawings. The following detailed description is provided to aid in a comprehensive understanding of the methods, apparatus and/or systems described herein. However, this is illustrative only, and the present disclosure is not limited thereto.

In describing the embodiments, when it is determined that a detailed description of related known technologies related to the present disclosure may unnecessarily obscure the subject matter of the present disclosure, a detailed description thereof will be omitted. In addition, terms to be described later are terms defined in consideration of functions in the present disclosure, which may vary according to the intention or custom of users or operators. Therefore, the definition should be made based on the contents throughout this specification. The terms used in the detailed description are only for describing embodiments, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

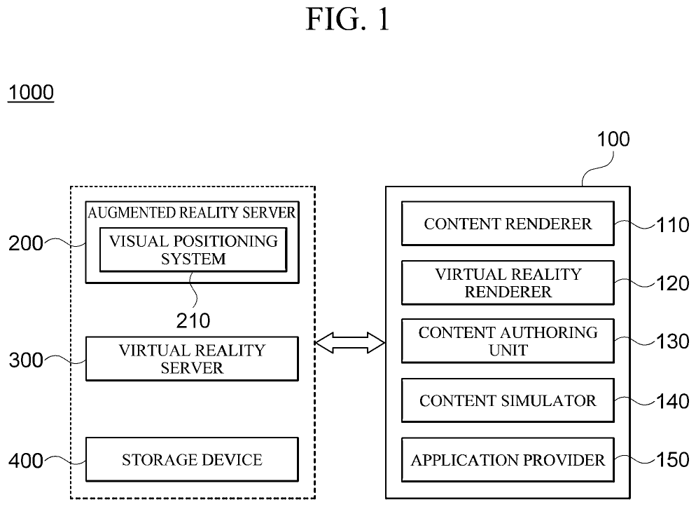

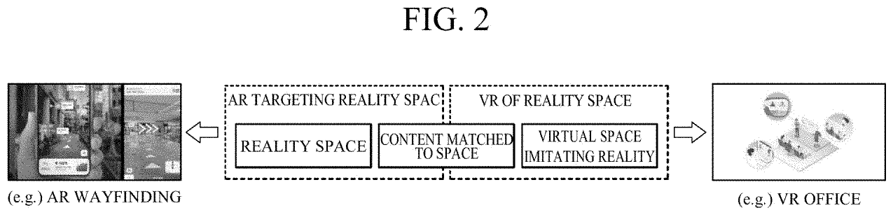

FIG. 1 is a block diagram for illustrating a realty space-based content authoring system according to an embodiment and FIG. 2 is a diagram for illustrating a rough concept of a realty space-based content authoring method according to an embodiment.

Referring to FIG. 1, a realty space-based content authoring system (hereinafter referred to as a ‘content authoring system’) 1000 includes a realty space-based content authoring device (hereinafter referred to as a ‘content authoring device’) 100, an augmented reality server 200, a virtual reality server 300, and a storage device 400.

In more detail, the augmented reality server 200 may provide augmented reality information including indoor and outdoor position information and simulation data of an augmented reality application user terminal necessary for simulation of content being authored and an operation of a distributed augmented reality application. In this case, the content may be augmented reality content. The indoor and outdoor position information of the augmented reality application user terminal described above may be obtained by a visual positioning system 210 to be described later.

Although not illustrated, the augmented reality server 200 may be configured as a subsystem for providing useful information when implementing augmented reality applications, including a visual positioning system (VPS) 210.

The visual positioning system 210 is a system for accurately estimating the indoor and outdoor position of an augmented reality (AR) application user terminal (not illustrated) equipped with a camera, and may provide an external camera parameter based on a two-dimensional image and GPS information obtained through the augmented reality application user terminal. The augmented reality application user terminal is a terminal equipped with a camera for taking an image. In this way, a position of the image obtained through the augmented reality application user terminal equipped with the camera may be ascertained through indoor and outdoor position information of the augmented reality application user terminal.

The two-dimensional image may include a real-time image frame provided by the camera of the augmented reality application user terminal, an image frame of a pre-stored video, and a pre-stored image. In this case, a type of the two-dimensional image may be any type without being limited to a specific type. The GPS information may include latitude and longitude. The GPS information may mean position information matched to the two-dimensional image. The external parameter of camera may mean a 6 degrees-of-freedom posture of the camera.

When implementing the augmented reality application described above, useful information may include simulation data. The simulation data may be composed of a sequence of video frames captured in a reality space and information corresponding to each frame. Information corresponding to each frame may include the camera internal parameter, the external parameter of camera, and position information. The camera internal parameter may include a focal length which is a distance between a lens center and an image sensor of the camera, a principal point, which is the center of the camera lens, a skew coefficient indicating the degree of inclination of the y-axis of a cell array of the image sensor, etc. The position information may be GPS information including latitude and longitude.

The simulation data described above may be acquired through a mobile application running on a specific platform. The acquired simulation data may be transmitted to and stored in the augmented reality server 200.

The virtual reality server 300 may be configured to provide reality space-based virtual reality information including geometric information and image information indicating a realty space to which content is to be applied in an authoring environment. The geometric information and image information may be used for virtual reality rendering, and may also be utilized in other methods to help content authoring.

The geometric information may be in a format including a point cloud format and a mesh format. In this case, the format is not limited to the point cloud format and the mesh format, and may further include other formats. The format of the point cloud may include ply in the form of a polygon file, and the format of the mesh may include obj and fbx. The geometric information may be compressed and provided for fast transmission. For example, the Draco three-dimensional data compression method may be applied to the compression of geometric information.

The image information described above may be provided in a 360-degree panoramic image or other format. In this case, the format of the 360-degree panoramic image may include ktx2 and basis. The image information may be compressed and provided for fast transmission. For example, the Basis Universal ultra-compression GPU codec may be used for the compression of image information.

The format and compression technique of the geometric information and image information are not limited to those described above, and may be changed to other formats and compression techniques according to the needs of an operator.

Meanwhile, the virtual reality server 300 may additionally provide other information necessary for a virtual reality (VR) environment in addition to geometric information and image information.

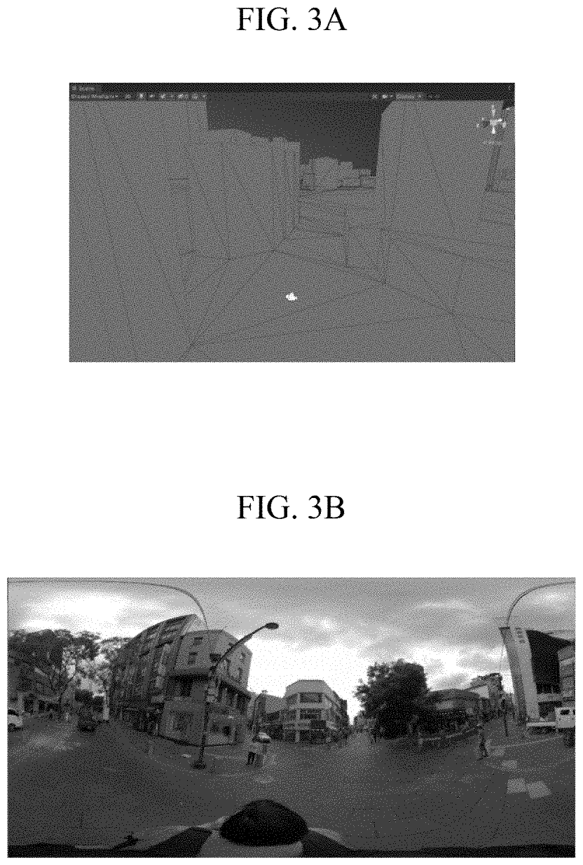

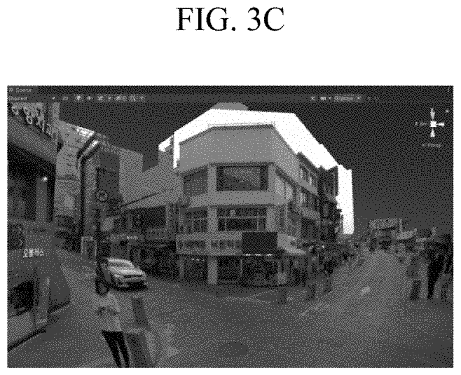

FIGS. 3A to 3C are diagrams illustrating examples of geometric information and image information described above and image-based rendering using the same according to an embodiment.

Specifically, FIG. 3A illustrates geometric information, FIG. 3B illustrates image information, and FIG. 3C illustrates an example of image-based rendering using the geometric information and image information of FIGS. 3A and 3B.

The content authoring device 100 may be configured to provide a reality space-based virtual reality authoring environment when producing content on the basis of augmented reality information and virtual reality information, and provide augmented reality application and virtual reality application based on the created content.

Referring to FIG. 2, these embodiments provide the reality space-based virtual reality authoring environment in which content that may be applied to both augmented reality (AR), which targets a reality space, and virtual reality (VR) of a reality space, which is a virtual space that imitates reality, can be authored. The reality-based virtual reality authoring environment may mean an environment provided to enable content to be authored in virtual reality to which a reality space is actually applied. In this case, since not only images of the realty space but also positions thereof are applied to the reality-based virtual reality authoring environment, and thus the content may be applied to both augmented reality application and virtual reality application.

As described above, in the disclosed embodiment, since content may be authored and placed in the virtual reality authoring environment modeled in a reality space, the effect that the user may check an output when the augmented reality application is executed in advance can be expected.

In addition, according to these embodiments, since content augmentation is simulated and provided using an image sequence acquired in the reality space, a sense of presence may be felt when authoring content. According to these embodiments, content augmentation can be simulated in various angles and situations with relatively little effort by placing content in an environment similar to an actual reality space without directly visiting the site.

Virtual content matched to a specific reality space according to these embodiments may be used in both the augmented reality application and the virtual reality application. For example, informational content displayed at each employee's seat in a virtual office may also be applied to augmented reality application targeting a real office. In contrast, the experience provided by augmented reality (AR) wayfinding application may be similarly reproduced in the virtual reality application.

Referring to FIG. 1, the content authoring device 100 described above may include a content renderer 110, a virtual reality renderer 120, a content authoring unit 130, a content simulator 140, and an application provider 150.

The content renderer 110 may be configured to perform rendering processing of content being authored or authored content.

The content renderer 110 may provide rendering of content being authored in an authoring environment, or may provide rendering of authored content when an augmented reality (AR) application and virtual reality (VR) application are executed. In this case, the authoring environment may mean the reality space-based virtual reality authoring environment.

Since content to be applied is authored according to the purpose of the application including the virtual reality application and the augmented reality application, the content renderer 110 may use various rendering techniques according to the content to be applied. For example, the content renderer 110 may use a dedicated software module or a general-purpose renderer.

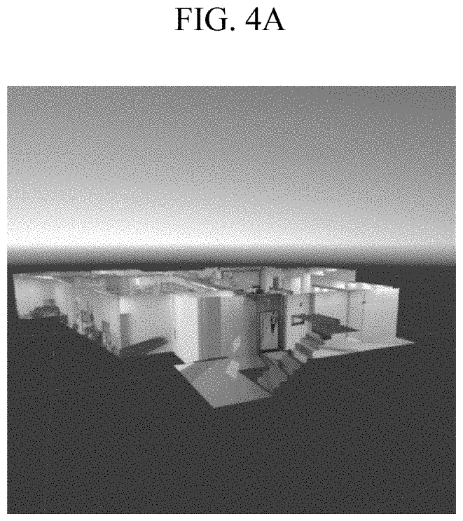

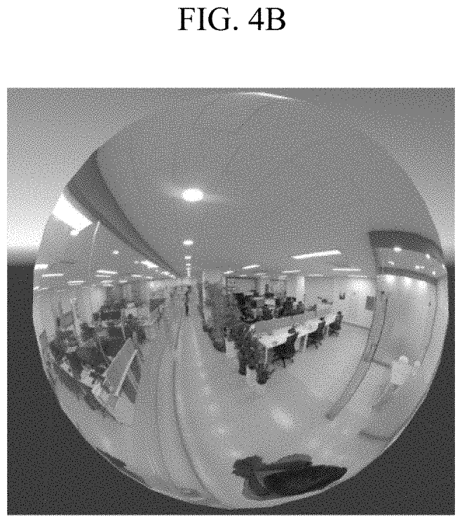

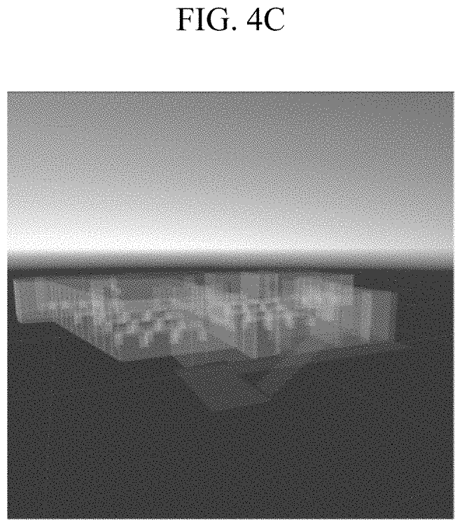

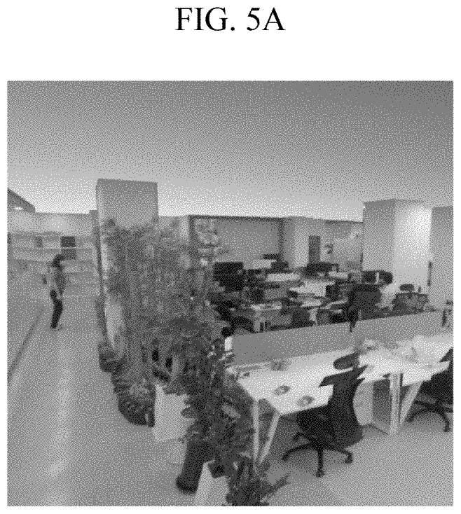

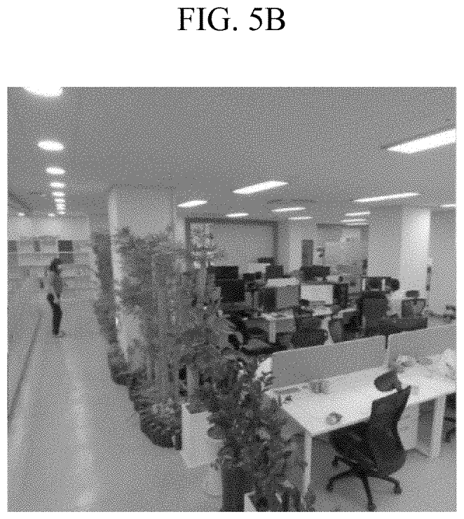

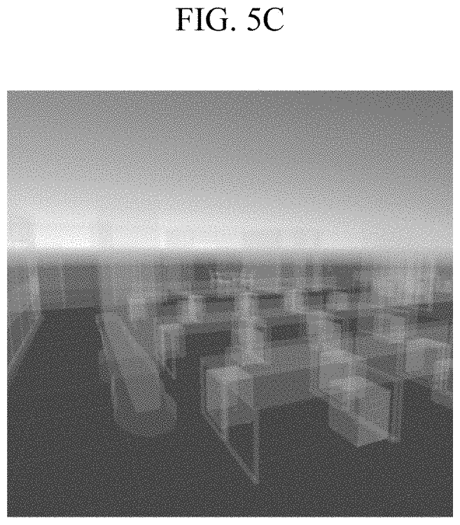

FIGS. 4A to 4C are diagrams illustrating examples of virtual reality rendering viewed from outside a space according to an embodiment and FIGS. 5A to 5C are diagrams illustrating examples of virtual reality rendering viewed from inside the space according to an embodiment.

The virtual reality renderer 120 may perform rendering processing of virtual reality corresponding to a reality space in the realty space-based virtual reality authoring environment by using at least one of geometric information and image information.

The virtual reality renderer 120 may provide rendering of the virtual reality corresponding to the reality space by utilizing geometric information and image information in the authoring environment. There is no limitation in the rendering method of the virtual reality, and any technique that utilizes both geometric information and image information, any technique that utilizes only the geometric information, or any technique that utilizes only the image information may be used.

As an example, referring to FIGS. 4A and 5A, the virtual reality renderer 120 may provide a three-dimensional virtual reality environment using the geometric information and image information. That is, the virtual reality renderer 120 uses both the geometric information and the image information during virtual reality rendering.

As another example, referring to FIGS. 4B and 5B, the virtual reality renderer 120 may provide a two-dimensional virtual reality environment in the reality space without the geometric information by using the image information. That is, the virtual reality renderer 120 uses only the image information during virtual reality rendering.

As still another example, referring to FIGS. 4C and 5C, the virtual reality renderer 120 may provide visualization in the virtual reality environment when authoring content using the geometric information. That is, the virtual reality renderer 120 uses only the geometric information during virtual reality rendering.

The virtual reality renderer 120 may apply a specific image-based rendering technique utilizing mesh information and a 360-degree panoramic image.

According to this embodiment, the virtual reality renderer 120 may prominently visualize and provide the geometric information for the purpose of helping content placement in the authoring environment. In this case, the geometric information visualization rendering technique may provide adjustable properties. For example, the virtual reality renderer 120 may display a rendering result to facilitate identification of the geometric information by adjusting color and transparency. In addition, the virtual reality renderer 120 may set the visualization described above to be provided only when content is authored and not be displayed during content simulation.

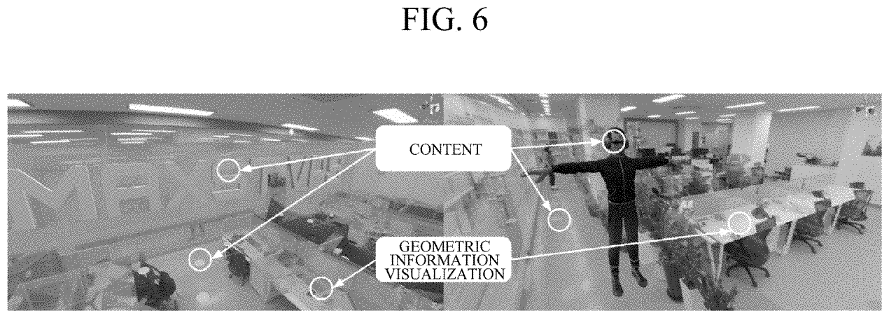

FIG. 6 is a diagram illustrating an example of rendering in the content authoring unit according to an embodiment.

The content authoring unit 130 may provide a series of interaction methods for the main purpose of content authoring and an environment including the same to a user of the authoring environment.

Referring to FIG. 6, the content authoring unit 130 may be configured to author content in the reality space-based virtual reality authoring environment, and to match and provide rendering of the virtual reality corresponding to the reality space and rendering of the content. Specifically, the content authoring unit 130 may match and provide the rendering of the virtual reality corresponding to the reality space to which the content being authored is applied and the rendering of the corresponding content by using the content renderer 110 and the virtual reality renderer 120. In this case, processing of the content renderer 110 and the virtual reality renderer 120 may be changed by the user of the authoring environment as needed. FIG. 6 illustrates an example of rendering of the content authoring unit 130 composed of rendering of the virtual reality, content placed in the virtual reality, and visualization of the geometric information.

Meanwhile, the content authoring unit 130 may be implemented by utilizing a dedicated software system or a general-purpose game engine, etc. in order not to limit the content that can be provided.

The content authoring unit 130 may perform content authoring processing by placing content and adjusting the position of the content according to a user's manipulation input in a specific space of the authoring environment of virtual reality. In this case, the position of the content may coincide with a position where the content will be displayed in the reality space when the augmented reality application is executed. To this end, the position applied to the reality space in the augmented reality may correspond to the position applied to the reality space implemented in the virtual reality. That is, when the augmented reality and the virtual reality target the same reality space, the positions may correspond to each other at this time.

The content authoring unit 130 may create and place a two-dimensional object or a three-dimensional object in the reality space-based three-dimensional virtual reality space according to the user's manipulation input, and match the rendering of virtual reality corresponding to the reality space to which the content being authored is applied with the rendering of content. In this case, the content authoring unit 130 may include an input/output function for creating and placing the two-dimensional or three-dimensional object in the three-dimensional space.

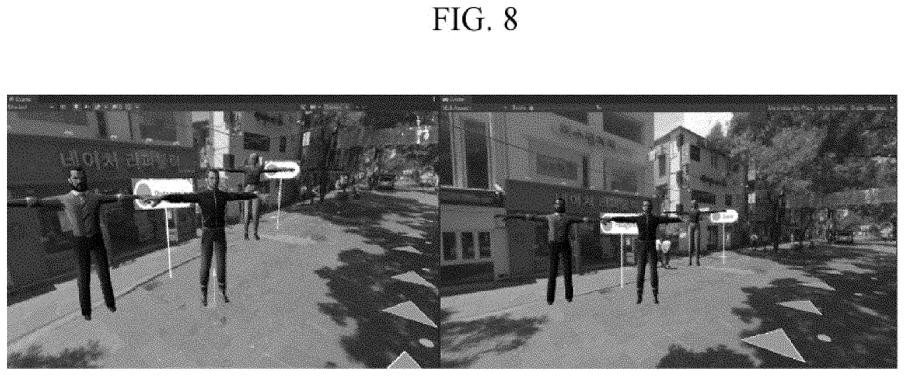

FIG. 8 is an exemplary diagram for illustrating an augmented reality content authoring method according to an embodiment, and may illustrate a case of authoring augmented reality (AR) wayfinding content.

The content simulator 140 may be configured to simulate the result when the augmented reality application and the virtual reality application to which the authored content is applied are executed.

In this case, the content simulator 140 may execute, pause, or stop the augmented reality (AR) application and the virtual reality (VR) application.

The content simulator 140 may be implemented by utilizing the same dedicated software system as that of the content authoring unit 130 or a general-purpose game engine.

The content simulator 140 may use both simulation data provided from the augmented reality server 200 and content rendering provided from the content renderer 110 when performing augmented reality (AR) content simulation. In this case, the content simulator 140 may include a process of transmitting an augmented reality information request to the augmented reality server 200 and receiving augmented reality information in response thereto. This process may be aimed at interacting with the visual positioning system 210. Specifically, the content simulator 140 may request information necessary for visual positioning to the augmented reality server 200, and accordingly, the augmented reality server 200 may return a visual positioning result to the content simulator 140. The information necessary for visual positioning may include a two-dimensional image and GPS information included in the simulation data. The visual positioning result may include the camera external parameter. In addition, the camera external parameter may be utilized to render the content by the content renderer 110.

The content simulator 140 may perform rendering using the content renderer 110 and the virtual reality renderer 120 in the same manner as the content authoring unit 130 in order to provide the same results as expected when authoring content, when performing virtual reality (VR) content simulation. In this case, the content simulator 140 may include a process of transmitting a virtual reality information request to the virtual reality server 300 and receiving the virtual reality information in response thereto. This process may be aimed at receiving image information necessary for updating virtual reality (VR) rendering in response to a change in location. Specifically, the content simulator 140 may transmit an identifier of image information to be received to the virtual reality server 300, and the virtual reality server 300 may return image information corresponding to the identifier to the content simulator 140. In this case, the identifier may be defined in any format capable of identifying the image information. In this case, the content simulator 140 may provide a specific interaction method necessary for the experience of the virtual reality (VR) environment. The interaction method may be implemented corresponding to various devices such as a keyboard, a mouse, a virtual reality (VR) headset, and a controller.

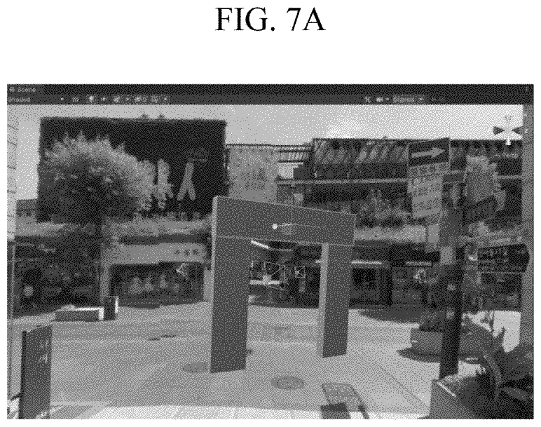

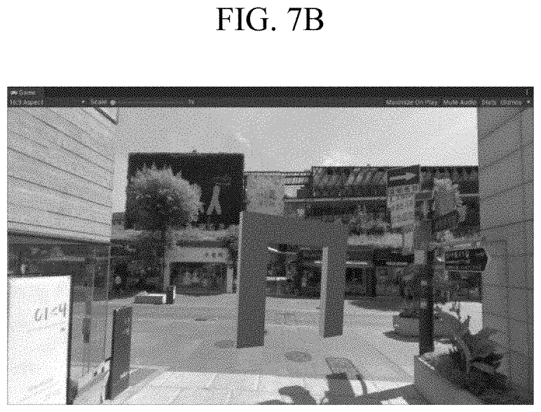

FIG. 7A is an exemplary diagram for illustrating an operation in the content authoring unit according to an embodiment and FIG. 7B is an exemplary diagram for illustrating an operation in the content simulator according to an embodiment.

The content simulator 140 may simulate the content (FIG. 7A) authored by the content authoring unit 130 and output the same result as in FIG. 7B.

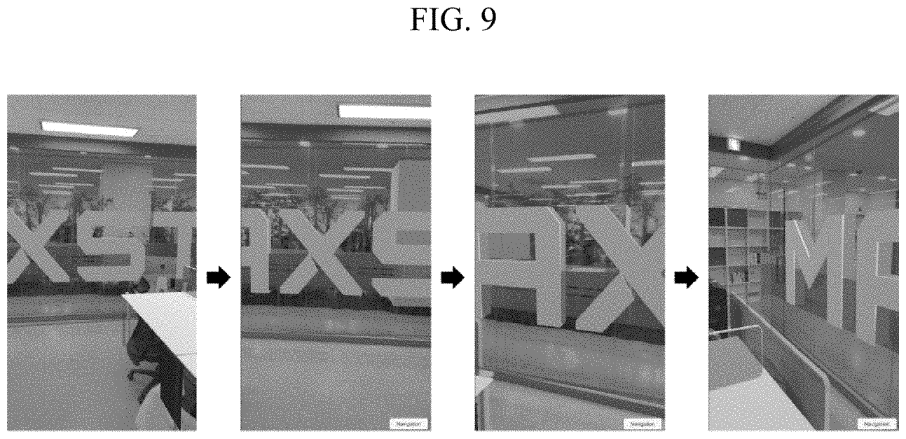

FIG. 9 is an exemplary diagram for illustrating an augmented reality content simulation method according to an embodiment, and may illustrate a case in which the augmented reality (AR) content simulation is displayed in the form of a video frame sequence.

The application provider 150 may be configured to provide the augmented reality application and the virtual reality application to which the authored content is applied, and to provide any one of the requested augmented reality application and virtual reality application to a selected platform. To this end, the application provider 150 may be configured to include an augmented reality distribution function, a virtual reality distribution function, a target application selection function, and a target platform selection function.

The application provider 150 may provide an integrated authoring environment by utilizing the same dedicated software system as that of the content processing unit 130 and content simulator 140 or a general-purpose game engine.

The storage device 400 may be configured to store and manage simulation data, geometric information, and image information to provide the stored information in response to a request of the content authoring device 100.

Specifically, the storage device 400 may store simulation data provided from the augmented reality server 200 and geometric information and image information provided from the virtual reality server 300 to be repeatedly utilized through the content authoring device 100. The data described above may be directly transmitted to the content authoring device 100 from the augmented reality server 200 and the virtual reality server 300, respectively, and then stored in the storage device 400 by the content authoring device 100.

The content authoring device 100 may repeatedly utilize data transmitted from the augmented reality server 200 and the virtual reality server 300 through any path, respectively, and stored in the storage device 400.

Meanwhile, the storage device 400 is not limited to that illustrated in FIG. 1, and may be installed in the content authoring device 100 and implemented in the form of an auxiliary storage device.

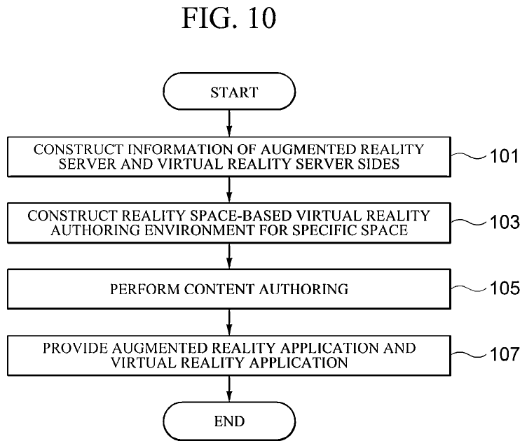

FIG. 10 is a flowchart for illustrating the reality space-based content authoring method according to an embodiment. The method illustrated in FIG. 10 may be performed, for example, by the content authoring system 1000 described above. In the illustrated flowchart, the method has been described by dividing the method into a plurality of steps, but at least some of the steps are performed in a different order, are performed together in combination with other steps, are omitted, are performed by being divided into sub-steps, or performed by adding one or more steps (not illustrated) thereto.

In step 101, the content authoring system 1000 may construct augmented reality information and virtual reality information.

Specifically, the augmented reality server 200 may construct the augmented reality information including indoor and outdoor position information and simulation data of the augmented reality application user terminal necessary for the simulation of the content being authored and the operation of the distributed augmented reality application. The virtual reality server 300 may construct the realty space-based virtual reality information including geometric information and image information indicating the reality space to which content is to be applied.

In step 103, the content authoring system 1000 may construct a reality space-based virtual reality authoring environment for a specific space in which content is to be authored.

In this case, the content authoring system 1000 may perform rendering processing of virtual reality corresponding to the reality space in the authoring environment by using the geometric information and the image information.

For example, the content authoring system 100 may prepare virtual reality information for a specific space in advance.

In step 105, the content authoring system 1000 may perform content authoring processing by placing content and adjusting the position of the content according to a user's manipulation input in the specific space.

For example, the content authoring system 1000 may retrieve and display virtual reality information for a specific space (e.g., Gangnam) in the authoring environment, and position the content in virtual reality. In this case, the content may be generated in advance or may be generated in the virtual reality. To this end, the content authoring system 1000 may provide various environments such as input/output for content authoring.

The content authoring system 1000 authorizes content in the reality space-based virtual reality authoring environment and may match the rendering of content with the rendering of the virtual reality corresponding to the reality space.

The content authoring system 1000 may simulate the result when the augmented reality application and the virtual reality application are executed on the basis of the authored content. The simulation of the virtual reality application may be displayed in the same way as when the content is positioned in the authoring environment. The simulation of the augmented reality application may be displayed as if directly visiting and viewing the corresponding site through the augmented reality application user's terminal such as a mobile phone.

In step 107, the content authoring system 1000 may provide the augmented reality application and the virtual reality application based on the authored content.

More specifically, the content authoring system 1000 may select an application intended to be provided among the augmented reality application and the virtual reality application. For example, the content authoring system 1000 may receive any one of the augmented reality application and the virtual reality application input according to a user's manipulation, and may determine the received application as selection information.

The content authoring system 1000 may select a platform to which any one of the selected augmented reality application and virtual reality application is to be applied.

The content authoring system 1000 may provide any one of the augmented reality application and the virtual reality application to the selected platform. In this case, the platform may be a mobile or web platform.

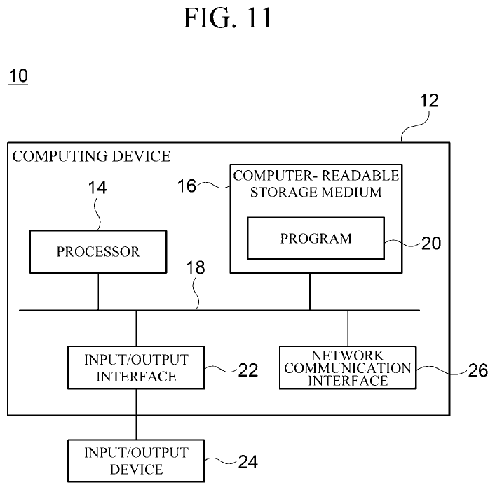

FIG. 11 is a block diagram illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In one embodiment, the computing device 12 may be the content authoring system 1000. In addition, the computing device 12 may be the content authoring device 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured such that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

Although the present disclosure has been described in detail through representative embodiments above, those skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents of the claims.

What is claimed is:

1. A reality space-based content authoring system comprising:
an augmented reality server configured to provide augmented reality information including indoor and outdoor position information and simulation data of an augmented reality application user terminal necessary for simulation of content being authored and an operation of a distributed augmented reality application;
a virtual reality server configured to provide reality space-based virtual reality information including geometric information and image information indicating a reality space to which the content is to be applied; and
a content authoring device configured to provide a reality space-based virtual reality authoring environment when producing the content on the basis of the augmented reality information and the virtual reality information, and provide an augmented reality application and a virtual reality application based on the created content.

2. The system of claim 1, wherein the content authoring device comprises:
a content renderer configured to perform rendering processing of content being authored or authored content;
a virtual reality renderer configured to perform rendering processing of virtual reality corresponding to a reality space in the reality space-based virtual reality authoring environment by using at least one of the geometric information and the image information, and provide a three-dimensional virtual reality environment using the geometric information and the image information, or providing a two-dimensional virtual reality environment of the reality space without the geometric information by using the image information, or providing visualization in a virtual reality environment when content is authored using the geometric information; and
a content authoring unit configured to author the content in reality space-based virtual reality authoring environment, and match and provide rendering of the virtual reality corresponding to the reality space and rendering of the content.

3. The system of claim 2, wherein the content authoring unit is configured to perform content authoring processing by placing the content and adjusting a position of the content according to a user's manipulation input in a specific space of the reality space-based virtual reality authoring environment, and the position of the content coincides with a position where the content is to be displayed in the reality space when the augmented reality application is executed.

4. The system of claim 2, wherein the content authoring device further includes a content simulator configured to simulate a result when the augmented reality application and the virtual reality application to which the authored content is applied are executed.

5. The system of claim 2, wherein the content authoring device further includes an application provider configured to provide the augmented reality application and the virtual reality application to which the authored content is applied, and provide any one of the requested augmented reality application and the virtual reality application to a selected platform.

6. The system of claim 2, wherein the content authoring unit is configured to generate and place a two-dimensional object or a three-dimensional object a reality space-based three-dimensional virtual reality space according to a user's manipulation input, and match the rendering of the content with the rendering of the virtual reality corresponding to the reality space to which the content being authored is applied.

7. The system of claim 1, further comprising:
a storage device configured to store and manage the simulation data, the geometric information, and the image information to provide the stored information in response to a request of the content authoring device.

8. The system of claim 1, wherein the simulation data is composed of a sequence of video frames captured in the reality space and information corresponding to each frame.

9. The system of claim 8, wherein the information corresponding to each frame includes a camera internal parameter, a camera external parameter, and position information.

10. The system of claim 9, wherein the position information is GPS information including latitude and longitude.

11. The system of claim 1, wherein the geometric information is in a format including a point cloud format and a mesh format.

12. A reality space-based content authoring device comprising:
a content renderer configured to perform rendering processing of content being authored or authored content;
a virtual reality renderer configured to perform rendering of virtual reality corresponding to a reality space in a reality space-based virtual reality authoring environment by using at least one of geometric information and image information, and provide a three-dimensional virtual reality environment using the geometric information and the image information, or provide a two-dimensional virtual reality environment of a reality space without the geometric information by using the image information, or provide visualization in a virtual reality environment when content is authored using the geometric information; and
a content authoring unit configured to author the content in the reality space-based virtual reality authoring environment, and match and provide rendering of the virtual reality corresponding to the reality space and rendering of the content.

13. The device of claim 12, wherein the content authoring unit is configured to perform content authoring processing by placing the content and adjusting a position of the content according to a user's manipulation input in a specific space of the reality space-based virtual reality authoring environment and the position of the content coincides with a position where the content is to be displayed in the reality space when the augmented reality application is executed.

14. The device of claim 12, wherein the content authoring unit is configured to generate and place a two-dimensional object or a three-dimensional object in a reality space-based three-dimensional virtual reality space according to a user's manipulation input, and match the rendering of the content with the rendering of the virtual reality corresponding to the reality space to which the content being authored is applied.

15. The device of claim 12, further comprising:
a content simulator configured to simulate a result when the augmented reality application and the virtual reality application are executed on the basis of the authored content; and
an application provider configured to provide the augmented reality application and the virtual reality application to which the authored content is applied, and provide any one of the requested augmented reality application and the virtual reality application to a selected platform.

16. A reality space-based content authoring method comprising:
constructing augmented reality information including indoor and outdoor position information and simulation data of an augmented reality application user terminal necessary for simulation of content being authored and an operation of a distributed augmented reality application;
constructing reality space-based virtual reality information including geometric information and image information indicating a reality space to which the content is to be applied;
constructing a reality space-based virtual reality authoring environment for a specific space in which content is to be authored;
performing content authoring processing by placing the content and adjusting the position of the content according to a user's manipulation input in the specific space; and
providing an augmented reality application and a virtual reality application based on the authored content.

17. The method of claim 16, wherein in the constructing of the reality space-based virtual reality authoring environment, rendering processing of virtual reality corresponding to the reality space in the authoring environment is performed using the geometric information and the image information.

18. The method of claim 16, wherein in the performing of the content authoring processing, the content is authored in the reality space-based virtual reality authoring environment, and the rendering of the virtual reality corresponding to the reality space is matched with the rendering of the content.

19. The method of claim 16, wherein in the performing of the content authoring processing, a result when the augmented reality application and the virtual reality application is executed on the basis of the authored content is simulated.

20. The method of claim 16, wherein the providing of the augmented reality application and the virtual reality application comprises:
selecting an application to be provided among the augmented reality application and the virtual reality application;
selecting a platform to which any one of the selected augmented reality application and the virtual reality application is to be applied; and
providing any one of the augmented reality application and the virtual reality application to the selected platform.
